(19) United States
(12) Patent Application Publication
(10) Pub. No.: US 2022/0299241 A1
(43) Pub. Date: Sep. 22, 2022

(54) APPARATUS AND METHOD FOR SEPARATING A WORKING FLUID FROM AN ABSORBENT

(71) Applicant: Barnieh Inventions Inc., Calgary (CA)

(72) Inventor: Raymond Asamoah-Barnieh, Calgary (CA)

(21) Appl. No.: 17/777,992

(22) PCT Filed: Nov. 22, 2019
(86) PCT No.: PCT/CA2019/051676

§ 371 Date: May 18, 2022

(51) Int. Cl. F25B 15/06; F25B 15/14; F25B 37/00; B01D 61/02; B01D 63/10

(52) U.S. Cl. CPC F25B 15/06; F25B 15/14; F25B 37/00; B01D 61/02; B01D 63/10; B01D 2311/25

(57) ABSTRACT

Improvements in technologies for separating a working fluid from an absorbent, such as in absorption heat pumps, are provided. An absorption based system may be operated under a thermodynamic cycle(s) that use a semipermeable barrier(s) and related technologies to continuously regenerate working solution and absorbent rather than relying solely on a thermally driven generator for the regenerative function. In an aspect, the system utilizes a differential solubility technique for regeneration in which a separator device has a semipermeable barrier and receives solution containing working fluid absorbed into an absorbent. A solubility reducing substance is mixed with the solution in the separator. The substance reduces the solubility of the working fluid in the absorbent to separate the two. The absorbent is permeable to the semipermeable barrier whereas the solubility reducing substance is not, thereby allowing absorbent to flow out of the separator while the substance is retained therein.

### FIELD

The present disclosure relates to apparatuses and methods for separating a working fluid from an absorbent, for example in absorption heat pumps.

### BACKGROUND

It is common for heat pumps to operate under a conventional vapour compression cycle, which requires using a compressor to drive fluid flow and that such compressors commonly consume more electrical energy compared to pumps that pump liquids, hereinafter referred to simply as pumps. Conventional absorption heat pumps operate under a cycle involving the use of one or more fluids, called the absorbent, to absorb one or more other fluids, the refrigerant, and this cycle eliminates the need for a compressor and rather uses a pump to drive fluid flow. This makes conventional absorption heat pumps more electrically efficient for the common case that pumps and compressors are electrically driven. However, conventional absorption heat pumps are typically inefficient from an overall energy perspective since they require a thermally driven generator to regenerate refrigerant and absorbent. Regeneration herein refers to the process of separating the working fluid from the absorbent in a solution comprising both working fluid and absorbent. Regeneration may refer to the process of separating the refrigerant from the absorbent in a solution flowing out of the absorber in the vapor absorption cycle of absorption heat pumps. Example refrigerants and absorbents are water and concentrated lithium bromide solution, and ammonia and weak aqueous ammonia solution. The resulting coefficients of performance are relatively lower than that of heat pumps operating under a conventional vapour compression cycle. For instance, conventional absorption heat pump cooling coefficients of performance tend to be in the neighbourhood of 0.7 relative to around 4.0 for conventional vapour compression heat pumps (see Johnson Controls 2018 pp. 12-13, p. 48). This reliance on a thermally driven generator also reduces the use of conventional absorption heat pumps to environments where there is adequate waste heat that can be used to drive the generator. This limitation restricts the widespread use of conventional absorption heat pumps, for instance in residential homes.

Improvements in apparatuses and methods for separating a working fluid from an absorbent are desired.

The above information is presented as background information only to assist with an understanding of the present disclosure. No assertion or admission is made as to whether any of the above, or anything else in the present disclosure, unless explicitly stated, might be applicable as prior art with regard to the present disclosure.

### SUMMARY

According to an aspect, the present disclosure is directed to a method comprising receiving a solution into a separator for separating a working fluid from an absorbent through an inlet of the separator, the solution containing working fluid absorbed into absorbent, providing a semipermeable barrier in the separator, the semipermeable barrier disposed upstream from an absorbent outlet of the separator, the absorbent being permeable to the semipermeable barrier, providing a solubility reducing substance in the separator to mix with the received solution, the solubility reducing substance reducing the solubility of the working fluid in the absorbent to desorb at least some of the working fluid from the absorbent thereby separating the at least some working fluid from the absorbent, wherein the solubility reducing substance is substantially impermeable to the semipermeable barrier, and wherein the solubility reducing substance is substantially not chemically consumed when it reduces the solubility of the working fluid, expelling the separated working fluid from the separator through a working fluid outlet, and passing absorbent through the semipermeable barrier and expelling the absorbent from the separator through the absorbent outlet.

In an embodiment, desorbing the working fluid from the absorbent involves at least in part vaporizing the absorbed working fluid into gaseous form by effervescence.

In an embodiment, the solubility reducing substance comprises a salt.

In an embodiment, the working fluid comprises ammonia and the absorbent comprises water.

In an embodiment, the working fluid outlet extends generally upwardly from an upper region of the separator containing the solution to promote the separating of the working fluid from the absorbent when the separated working fluid is in gaseous form.

In an embodiment, the flow velocity of the solution through the inlet is higher than the speed of diffusion of the solubility reducing substance in the solution to inhibit diffusion of the solubility reducing substance outwardly of the separator through the inlet.

In an embodiment, the method further comprises circulating the solution within the separator across a surface of the semipermeable barrier.

In an embodiment, the method further comprises pumping the solution across a surface of the semipermeable barrier at a pressure to enable the absorbent to permeate through the semipermeable barrier.

In an embodiment, the method further comprises circulating the solution in the separator in a first channel forming a first fluid loop, the first channel in fluid communication with the semipermeable barrier.

In an embodiment, the method further comprises the method further comprises circulating the solution in the separator in a second channel forming a second fluid loop, the second channel in fluid communication with the semipermeable barrier and the first channel, wherein a fluid pressure at an inlet of a second pump in the second channel is higher than a fluid pressure at an inlet of a first pump in the first channel.

In an embodiment, the method further comprises removing accumulated solubility reducing substance from an evaporator that is in fluid communication with the separator.

In an embodiment, the removing comprises moving at least some of the accumulated solubility reducing substance into the separator.

In an embodiment, the method further comprises removing accumulated absorbent from an evaporator that is in fluid communication with the separator.

In an embodiment, the semipermeable barrier comprises a semipermeable membrane.

In an embodiment, the semipermeable barrier comprises a cross flow membrane and the solution is flowed tangentially across a surface of the membrane.

In an embodiment, the method further comprises adding heat to and/or removing heat from the solution in the separator to augment the solubility reducing effect of the solubility reducing substance.

In an embodiment, the solubility reducing substance is provided and mixes with the received solution in a desorption chamber of the separator, and the method further comprises transferring heat from solution flowing in an outwardly direction in the separator relative to the desorption chamber to solution in the desorption chamber and/or to solution flowing in an inwardly direction in the separator relative to the desorption chamber.

In an embodiment, the method further comprises transferring heat from solution flowing upstream from the semipermeable barrier in the separator to a heat sink for lowering the temperature of said solution.

In an embodiment, the separator is a part of a heat pump, and the working fluid is a refrigerant.

According to an aspect, the present disclosure is directed to an apparatus comprising a separator for separating a working fluid from an absorbent, the separator comprising an inlet for receiving a solution into the separator, the solution containing working fluid absorbed into absorbent, an absorbent outlet for expelling absorbent from the separator, a working fluid outlet for expelling separated working fluid from the separator, and a semipermeable barrier disposed upstream from the absorbent outlet, wherein a solubility reducing substance is receivable into the separator to mix with the received solution, the solubility reducing substance reducing the solubility of the working fluid in the absorbent to desorb at least some of the working fluid from the absorbent thereby separating the at least some working fluid from the absorbent, wherein the solubility reducing substance is substantially impermeable to the semipermeable barrier, and wherein the solubility reducing substance is substantially not chemically consumed when it reduces the solubility of the working fluid, wherein the semipermeable barrier is configured to permeate absorbent through the semipermeable barrier, and the separator is configured to expel the permeated absorbent through the absorbent outlet.

In an embodiment, desorbing the working fluid from the absorbent involves at least in part vaporizing the absorbed working fluid into gaseous form by effervescence.

In an embodiment, the working fluid outlet extends generally upwardly from an upper region of the separator containing the solution to promote the separating of the working fluid from the absorbent when the separated working fluid is in gaseous form.

In an embodiment, the inlet comprises a narrowed portion to cause the flow velocity of the solution through the inlet to be higher than the speed of diffusion of the solubility reducing substance in the solution to inhibit diffusion of the solubility reducing substance outwardly of the separator through the inlet.

In an embodiment, the separator further comprises a pump for pumping the solution across a surface of the semipermeable barrier at a pressure to enable the absorbent to permeate through the semipermeable barrier.

In an embodiment, the separator defines a first channel forming a first fluid loop for circulating the solution in the separator, the first channel in fluid communication with the semipermeable barrier.

In an embodiment, the separator defines a second channel forming a second fluid loop for circulating the solution in the separator, the second channel in fluid communication with the semipermeable barrier and the first channel, the separator comprises a first pump in the first channel and a second pump in the second channel, and a fluid pressure at an inlet of the second pump is higher than a fluid pressure at an inlet of the first pump.

In an embodiment, the apparatus further comprises an evaporator in fluid communication with the separator, and a drain path for removing accumulated solubility reducing substance from the evaporator.

In an embodiment, the drain path fluidly connects the evaporator and the separator for moving at least some of the accumulated solubility reducing substance into the separator.

In an embodiment, the apparatus further comprises an evaporator in fluid communication with the separator, and a drain path for removing accumulated absorbent from the evaporator.

In an embodiment, the semipermeable barrier comprises a semipermeable membrane.

In an embodiment, the semipermeable barrier comprises a cross flow membrane.

In an embodiment, the apparatus further comprises a heat exchanger for adding heat to and/or removing heat from the solution in the separator to augment the solubility reducing effect of the solubility reducing substance.

In an embodiment, the separator defines a desorption chamber for receiving the solution and the solubility reducing substance, and wherein the separator comprises a heat exchanger for transferring heat from solution flowing in an outwardly direction in the separator relative to the desorption chamber to solution in the desorption chamber and/or to solution flowing in an inwardly direction in the separator relative to the desorption chamber.

In an embodiment, the separator comprises a heat exchanger disposed upstream from the semipermeable barrier for transferring heat from solution flowing to the semipermeable barrier to a heat sink for lowering the temperature of said solution.

In an embodiment, the separator is a part of a heat pump, and the working fluid is a refrigerant.

In an embodiment, the apparatus comprises the solubility reducing substance.

In an embodiment, the solubility reducing substance comprises a salt.

In an embodiment, the working fluid comprises ammonia and the absorbent comprises water.

According to an aspect, the present disclosure is directed to a method comprising receiving a solution into a separator for separating a working fluid from an absorbent, the solution containing working fluid absorbed into absorbent, providing a semipermeable barrier in the separator, the semipermeable barrier disposed upstream from a working fluid outlet of the separator, the working fluid being permeable to the semipermeable barrier, pumping the solution across a surface of the semipermeable barrier at a pressure to enable working fluid to permeate through the semipermeable barrier, thereby separating at least some of the working fluid from the absorbent, expelling the separated working fluid from the separator through the working fluid outlet, expelling absorbent from the separator through an absorbent outlet, and removing accumulated absorbent from an evaporator that is in fluid communication with the separator.

In an embodiment, the removing accumulated absorbent comprises moving at least some of the accumulated absorbent into the separator.

In an embodiment, the removing accumulated absorbent comprises moving at least some of the accumulated absorbent into an absorber that is in fluid communication with the evaporator.

In an embodiment, the removing accumulated absorbent is performed intermittently.

In an embodiment, the removing accumulated absorbent is performed continuously.

In an embodiment, the accumulated absorbent flowed to the evaporator from the separator due to imperfect rejection of the absorbent by the semipermeable barrier.

In an embodiment, the working fluid comprises water and the absorbent comprises lithium bromide.

In an embodiment, the method comprises passing at least part of the solution in the separator across the surface of the semipermeable barrier multiple times.

In an embodiment, the semipermeable barrier comprises a semipermeable membrane.

In an embodiment, the separator is a part of a heat pump, and the working fluid is a refrigerant.

According to an aspect, the present disclosure is directed to an apparatus, comprising a separator for separating a working fluid from an absorbent, the separator comprising an inlet for receiving a solution into the separator, the solution containing working fluid absorbed into absorbent, an absorbent outlet for expelling absorbent from the separator, a working fluid outlet for expelling separated working fluid from the separator, a semipermeable barrier disposed upstream from the working fluid outlet, wherein when the solution is pumped across the semipermeable barrier, the working fluid is permeable to the semipermeable barrier to separate at least some of the working fluid from the absorbent, and a first drain path fluidly connected to an evaporator for removing accumulated absorbent from the evaporator.

In an embodiment, the drain path fluidly connects the evaporator and the separator for moving at least some of the accumulated absorbent to the separator.

In an embodiment, the apparatus comprises a second drain path fluidly connecting the evaporator with an absorber for moving at least some of the accumulated absorbent to the absorber.

In an embodiment, the removing or moving of the accumulated absorbent is performed intermittently.

In an embodiment, the removing or moving of the accumulated absorbent is performed continuously.

In an embodiment, the working fluid comprises water and the absorbent comprises lithium bromide.

In an embodiment, the separator defines a recirculation fluid loop between the inlet and the absorbent outlet for recirculating the solution over the semipermeable barrier.

In an embodiment, the apparatus comprises a pump for further pressurizing the solution in the recirculation fluid loop.

In an embodiment, the semipermeable barrier comprises a semipermeable membrane.

In an embodiment, the separator is a part of a heat pump, and the working fluid is a refrigerant.

The foregoing summary provides some aspects and features according to the present disclosure but is not intended to be limiting. Other aspects and features of the present disclosure will become apparent to those ordinarily skilled in the art upon review of the following description of specific embodiments in conjunction with the accompanying figures. Accordingly, the drawings and detailed description are to be regarded as illustrative in nature and not restrictive.

### BRIEF DESCRIPTION OF THE DRAWINGS

Embodiments of the present disclosure will now be described, by way of example only, with reference to the attached Figures.

FIG. 1 is a schematic of an example embodiment of a heat pump according to the present disclosure that utilizes a pressure driven technique to regenerate the working fluid and the absorbent.

FIG. 2 is a conceptual diagram of an example embodiment of a flow and separation process in a separator.

FIG. 3 is a diagram of an example embodiment of a structure for a flow and separation process in a separator.

FIG. 4 is a schematic of another example embodiment of a heat pump according to the present disclosure comprising multiple optional drain paths.

FIG. 5 is a schematic of another example embodiment of a heat pump according to the present disclosure configured to operate with a modified absorption cycle.

FIG. 6 is a schematic of another example embodiment of a heat pump according to the present disclosure configured to operate with a re-sequenced absorption cycle.

FIGS. 7-8 are schematics of other example embodiments according to the present disclosure configured for application in desiccant dehumidification humidification applications.

FIG. 9 is an example process flow diagram according to the present disclosure.

FIG. 10 is a schematic of an example embodiment of a heat pump according to the present disclosure having a separator that utilizes a differential solubility technique to regenerate the working fluid and the absorbent.

FIG. 11 is a conceptual diagram of an example embodiment of a flow and separation process in a differential solubility separator.

FIG. 12 is a diagram of an example embodiment of a structure for a flow and separation process in a differential solubility separator.

FIG. 13 is a diagram of an example embodiment of a structure for a flow and separation process in a differential solubility separator having a second recirculation loop.

FIG. 14 is a schematic of another example embodiment of a heat pump according to the present disclosure having multiple optional drain paths.

FIG. 15 is a schematic of another example embodiment of a heat pump according to the present disclosure having a separator similar to the one of FIG. 13, which may take advantage of available waste heat for increasing cooling capacity.

FIG. 16 is a schematic of another example embodiment of a heat pump according to the present disclosure that utilizes a differential solubility separator according to FIG. 17.

FIG. 17 is a diagram of a differential solubility separator according to the present disclosure.

FIG. 18 is is a schematic of another example embodiment of a heat pump according to the present disclosure.

FIG. 19 is an example process flow diagram according to the present disclosure.

FIG. 20 is a block diagram of an example electronic device that may be used in implementing one or more aspects or components of an embodiment according to the present disclosure.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

The present disclosure generally relates to improvements in technologies for separating a working fluid from an absorbent, for example in absorption heat pumps. In particular, the present disclosure generally relates to absorption technologies and systems that eliminate or reduce the need for a thermally driven generator to continuously regenerate working fluid and absorbent. Again, regeneration herein refers to the process of separating the working fluid from the absorbent in a solution comprising both working fluid and absorbent. Such solutions can be found in a vapor absorption cycle of an absorption based system.

For descriptive purposes, several aspects, embodiments, and features according to the present disclosure are described in relation to heat pumps and where the working fluid is a refrigerant. However, this is not intended to be limiting. The teachings according to the present disclosure may be applied to fields and technologies other than heat pumps and to working fluids other than refrigerants. Examples of other applications are the liquor distilleries industry (desorbing alcohol from an alcohol-water mix to produce more concentrated drinkable alcohols), and pharmaceuticals and chemical separation processes.

To be sustainably ecofriendly, economical for users, and also contribute to global efforts to reduce carbon footprint in an era of increased climate change awareness, it may be desirable for heat pumps used for diverse applications such as refrigerators, freezers, chillers, building heating (HVAC), water heating, air conditioners, and atmospheric water generators to be energy efficient and have low operating costs.

According to the present disclosure, a heat pump may be operated under one or more thermodynamic cycles that involve using one or more semipermeable barriers or membranes, and technologies enabled by them, to continuously regenerate refrigerant and absorbent in an absorption heat pump rather than relying solely on a thermally driven generator for the regenerative function. The result is an absorption heat pump that is typically more energy efficient than conventional absorption heat pumps. Certain embodiments have shown potential for energy savings in excess of 50% relative to conventional vapour compression refrigerators.

In an aspect, the heat pump utilizes a pressure driven technique to regenerate the refrigerant and the absorbent.

In an aspect, the heat pump utilizes a differential solubility technique to regenerate the refrigerant and the absorbent.

In an aspect, a heat pump may include one or more drain paths for removing solutes, such as absorbent and/or refrigerant, from parts of the system where they are generally not desired. Solutes may end up in these parts due to, for example, imperfect solute rejection rates by a semipermeable membrane, solute spills for instance due to mishandling of the heat pump, or non-zero solubility of a solubility reducing substance solute in a liquid separated fluid.

Other aspects and advantages according to the present disclosure will be apparent from the following taken in conjunction with the accompanying drawings wherein are set forth, by way of illustration and example, certain embodiments according to the present disclosure.

Pressure Driven Technique for Regeneration

An improved heat pump according to the present disclosure uses a semi-permeable barrier or membrane to enable refrigerant and absorbent to be regenerated by suitable application of pressure to the inflow feedstock of the membrane. A main energy input is the pump work, meaning the energy for pumping a liquid from the low pressure side (low side) to the high pressure side (high side) of the heat pump with consideration for the additional pump work needed to overcome the osmotic pressure of the absorbent and any other component of the transmembrane operating pressure of the selected semi-permeable membrane for the selected refrigerant and absorbent and their flow rates.

Prior heat pumps suffer from the limitation of requiring a semi-permeable membrane with a perfect solute rejection rate of exactly 100%, which is a condition often not met in currently available semi-permeable membranes. Such membranes can have a rejection rate above 99% but never exactly 100% specified in their manufacturer's data sheet (see LANXESS AG 2019; Synder® Filtration 2019), a limitation herein referred to as ‘imperfect solute rejection’. This limitation results in the accumulation of absorbent solutes in the evaporator of heat pumps over time which raises the boiling point of the refrigerant in the evaporator and reduces the absorption rate of the absorbent in the absorber. This degrades performance of the heat pump until the absorbent solute concentration in the refrigerant in the evaporator becomes equal to that of the absorbent in the absorber, at which point the absorption heat pump ceases to be functional.

According to the present disclosure, this limitation of imperfect solute rejection is overcome by incorporating drain paths to drain solute-laden liquid refrigerant away from the evaporator to keep the absorbent solute concentration in the evaporator below tolerance values to maintain the heat pump performance of interest.

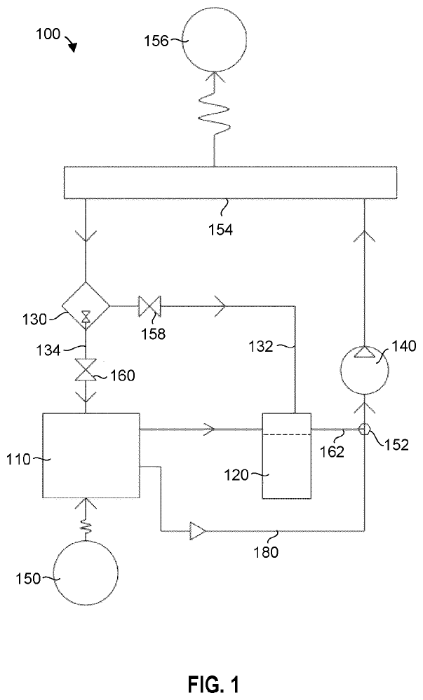

FIG. 1 is a schematic of an example embodiment of a heat pump 100 according to the present disclosure.

In an embodiment, heat pump 100 is an improvement over a conventional absorption heat pump such as a lithium bromide (LiBr) absorption heat pump. Heat pump 100 may operate with some similar processes of a lithium bromide conventional absorption heat pump. However, heat pump 100 may comprise one or more improvements. For example, heat pump 100 may employ improved techniques to regenerate the refrigerant, here the working fluid, and the absorbent. Additionally or alternatively, heat pump 100 may employ one or more drain paths for removing absorbent solutes, from parts of the system where they are generally not desired, in some cases thereby improving the efficiency and/or performance of the heat pump. A drain path may take any suitable form, such as a tube, pipe, channel, etc.

The structure and a possible general mode of operation of heat pump 100 are now described.

A refrigerant, for example comprising water, enters evaporator 110 at a low pressure (the low side of refrigeration). Evaporator 110 may include a heat exchanger assembly. The refrigerant absorbs heat from a heat source 150, such as a cold refrigerated space, and evaporates in the process. The absorption of heat by evaporator 110 is indicated by the squiggly arrow from heat source 150 towards evaporator 110. The evaporated refrigerant is then absorbed by the absorbent, such as concentrated aqueous lithium bromide solution also known as strong solution by persons of ordinary skill in the art, in an absorber assembly 120. The molar concentrations of lithium bromide in the concentrated aqueous lithium bromide solution are within the knowledge of persons of ordinary skill in the art. Absorber 120 may include other components such as one or more heat exchangers to extract heat from the absorber fluids. In this particular embodiment, it is assumed that the absorption results in a temperature rise. In other words, it is an exothermic process and the absorbent has a negative enthalpy of solvation. The resulting weak absorbent solution, such as dilute aqueous lithium bromide solution, then passes through a valve 152 to a pump 140. This weak absorbent solution has a lower molar concentration of lithium bromide relative to that of the concentrated aqueous lithium bromide solution aforementioned. Valve 152 may be normally open to this flow path from absorber 120 to pump 140, and may be closed to a drain path 180 from evaporator 110.

The weak absorbent solution is then pumped to the high side of refrigeration where it may flow through a heat exchanger assembly 154 to reject heat to a heat sink 156, such as a heated space or ambient environment. The weak absorbent solution is thus cooled down. The weak absorbent solution may then enter a separator 130 to separate refrigerant from absorbent. A separator is sometimes herein referred to as a regenerator in the sense that it regenerates refrigerant and absorbent. Separator 130 comprises a semipermeable barrier, such as a semipermeable membrane, for use in separating the refrigerant from the absorbent where the refrigerant is permeable to the semipermeable barrier. Semipermeable barrier may be formed by one or more semipermeable barrier elements. In this embodiment, separator 130 is in the form of a pressure driven membrane transition (MT) separator. Separator 130 is illustrated with a bow tie symbol representing a throttling function of the semipermeable barrier. The weak absorbent solution within separator 130 is at a pressure high enough to overcome the transbarrier operating pressure for the particular semipermeable barrier thereby allowing the refrigerant to permeate and pass through the semipermeable barrier. The semipermeable barrier is chosen so that the absorbent is generally impermeable to the barrier, such that the barrier contributes to the separation function of the separator 130.

Although the working solution or refrigerant may comprise water, and the absorbent may comprise lithium bromide, this is not meant to be limiting. The working solution and/or absorbent may consist or comprise of any other suitable solutes or substances.

In previous systems, separator 130 is in the form of a thermally driven generator to regenerate refrigerant and absorbent. These systems rely solely on a thermally driven generator for the regenerative function. In contrast, in accordance with the present disclosure, the separator is not solely thermally driven. In some embodiments, the separator does not require any thermal input.

Referring again to FIG. 1, the concentrated absorbent solution may then flow from separator 130 to absorber assembly 120 via path 132 to continue the absorption cycle.

The concentrated absorbent solution flowing toward absorber 120 via path 132 may first be channeled through a throttle valve 158 to be throttled to a lower pressure (the low side of refrigeration) before arriving at absorber 120. A need for throttling may change though depending on the type of absorber being used, for instance, the sprinkler in sprinkler absorbers may effectively function as a throttling device to eliminate the need for an upstream throttle device. The separated refrigerant emerging from an outlet of separator 130, on the other hand, may flow to evaporator 110 via path 134 and may be throttled through the throttle valve 160 to a lower pressure (the low side of refrigeration) to continue the refrigeration cycle. Throttle valve 160 may be omitted when the semipermeable barrier in separator 130 functions as a throttle valve under an appropriate system configuration so that refrigerant exiting separator 130 into path 134 is at a pressure equal to or around the required pressure for the low side of refrigeration, meaning the evaporator pressure.

Periodically, valve 152 may be opened to the drain path 180 and closed to the flow path 162 from absorber 120 to pump 140. During these periods, absorbent-solute laden liquid refrigerant may be removed from evaporator 110 and heat exchanger assembly via drain path 180 to keep the absorbent solute concentrations in evaporator 110 below threshold levels, which may be significantly detrimental to the evaporation and absorption process. The determination of an appropriate drainage frequency may be a design decision and/or an optimization problem to be solved by the designer of the specific system.

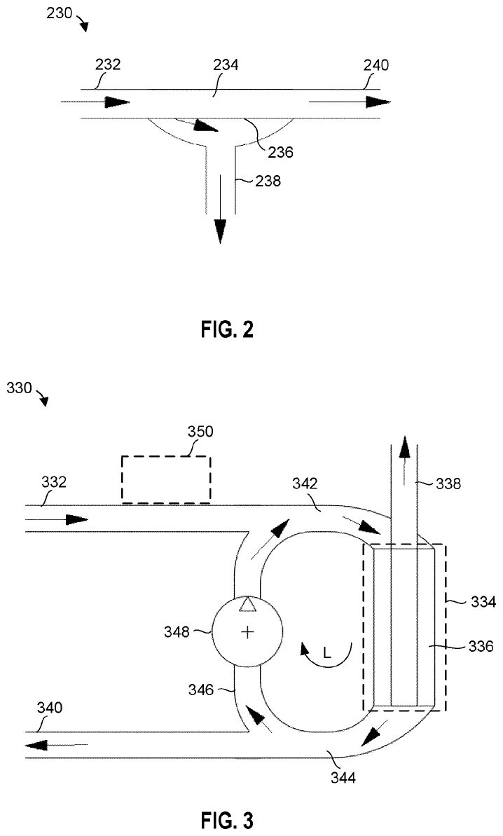

FIG. 2 is a conceptual diagram of an example embodiment of a flow and separation process in a separator 230. Weak absorbent solution is fed into the separator 230 via inlet 232. The solution is received in a chamber, channel, or other opening 234 within separator 230. A semipermeable barrier 236 such as a semipermeable membrane is disposed within separator 230 between chamber 234 and an outlet 238 of separator 230. In this sense, barrier 236 is upstream from outlet 238. Outlet 238 may be a refrigerant outlet. In an embodiment, separator 230 may comprise a spiral wound cross-flow membrane device, such as a commercially available spiral wound membrane. In general, any suitable type(s) of semipermeable barriers may be used, including nanofiltration membranes and/or reverse osmosis membranes.

The weak absorbent solution is fed to separator 230 at a pressure high enough to meet the transbarrier or transmembrane operating pressure for the particular semipermeable barrier 236 and weak absorbent solution flowing through separator 230, such as a weak absorbent solution comprising unsaturated aqueous lithium bromide. These pressures are within the knowledge of persons of ordinary skill in the art. As with many semipermeable membranes, the transmembrane operating pressure is the average pressure difference across the semipermeable membrane. Within a cross-flow semipermeable membrane, the refrigerant, for instance water, passes through the semipermeable barrier 236 and is expelled from the separator 230 through refrigerant outlet 238 to flow toward evaporator 110 (FIG. 1), whereas the concentrated absorbent solution, for example concentrated lithium bromide solution, is generally impermeable to barrier 236 and is expelled from separator 230 through absorbent outlet 240 to flow toward absorber assembly 120 (FIG. 1). In this way, separator 230 separates refrigerant from absorbent.

FIG. 3 is a diagram of an example embodiment of a structure for a flow and separation process in a separator 330 having an inlet 332, a refrigerant outlet 338, and an absorbent outlet 340. Region 334 of separator 330 may comprise structure that corresponds to the conceptual diagram of separator 230 of FIG. 2. Conceptually, inlet 232 corresponds to path 342, absorbent outlet 240 corresponds to path 344, and refrigerant outlet 238 corresponds to refrigerant outlet 338. Region 334 comprises a chamber, channel, or other opening similar to chamber 234, and a semipermeable barrier 336, such as a semipermeable membrane, disposed within separator 330 between the chamber and an outlet 338 of separator 330. Semipermeable barrier 336 may comprise a spiral wound cross-flow membrane. Separator 330 may also have pump 348 and channel 346 in this embodiment.

With reference to the implementation represented in FIG. 2, similar or higher efficiencies may be achieved with the embodiment according to FIG. 3 by possibly using a fewer semipermeable barrier elements and/or by feeding at least part of the solution in separator 330 to semipermeable barrier 336 multiple times. In other words, some of the solution that has passed over semipermeable barrier 336, for example solution in path or region 344 of separator 330, is expelled via absorbent outlet 340 while some of the solution is directed into path or channel 346 to be reintroduced into path 342 upstream of semipermeable barrier 336. In effect, this solution in channel 346 is recirculated over semipermeable barrier 336. Path 346 thereby forms a recirculation fluid loop L in separator 330. The solution in path 346 may be referred to as a high pressure recirculating stream. A pump 348 may be used to provide pressure required to overcome a cross-flow pressure drop across semipermeable barrier 336 to the high pressure recirculating stream in path 346. A high pressure recirculation ratio, defined as a percentage of the flow through path 344 flowing through high pressure recirculating stream in path 346 may be a design parameter to be selected to, for example, optimize energy efficiency. This may be an optimization problem to be solved by a designer of the system having ordinary skill in the art. In another embodiment, pump 348 may not be required, for example if a pump external to separator 330 provides sufficient fluid pressure to overcome a cross-flow pressure drop across semipermeable barrier 336.

FIG. 3 additionally shows an optional heat exchanger 350. The function of heat exchanger 350 may be used to transfer heat from the fluid about to flow over semipermeable barrier 336 to a heat sink such as ambient to attempt to maintain a relatively low temperature at semipermeable barrier 336. This may assist in maintaining lower osmotic pressures at semipermeable barrier 336 and/or ensure the temperatures at semipermeable barrier 336 are below a maximum operating temperature, for example specified by a manufacturer of semipermeable barrier 336.

Existing commercially available semipermeable membranes can typically have imperfect solute rejection rates with typical solute rejection rates being 99.5% or better (see LANXESS AG 2019; Synder Filtration 2019). Thus around 0.5% of the absorbent solute, such as lithium bromide, filters through the semipermeable membrane. Accordingly, in absorption based systems, such as absorption heat pumps, absorbent accumulates in the evaporator and heat exchanger assembly. As the refrigerant evaporates, the absorbent solutes are left behind. Over time, the absorbent builds up in the evaporator and the concentration of absorbent solutes in the evaporator eventually becomes equal to the concentration in the absorber assembly. This condition causes the absorption process to cease and brings the refrigeration or other cycle to a halt. This problem plagues the application of current commercially available semipermeable membranes.

Prior absorption based systems, such as absorption heat pumps, ideally require a semipermeable membrane with a perfect solute rejection rate, meaning a rejection rate of 100%, in order to avoid this problem of absorbent accumulating in the evaporator. A perfect solute rejection rate is not typically met in commercial semipermeable membranes (see LANXESS AG 2019; Synder Filtration 2019). When such currently available commercially produced semipermeable membranes are used in the present separator, any liquid containing absorbent solute in the evaporator and possibly in the flow paths between the separator and the evaporator may be drained or otherwise removed either periodically, intermittently or continuously. This may ensure the solute concentration in the evaporator and the flow paths between the separator and evaporator are kept below a threshold concentration so as to not adversely interfere with the evaporation and absorption process taking place across the evaporator and absorber.

When absorbent is drained periodically, the period between successive drainages may be determined by the designer for example based on parameters such as: the solute rejection rate of the semipermeable barrier, the permeate flow rate of the semipermeable barrier or membrane (refrigerant flow rate in this case), and/or the typical volume of liquid in the evaporator and the desired maximum concentration of solute in the evaporator (meaning tolerance values for absorbent solute concentration in evaporator).

With reference to FIG. 1, to drain the evaporator and heat exchanger assembly 110, an on-off one-way valve at a drain path 180 may be periodically opened while valve 152 is simultaneously periodically closed to the flow path 162 from absorber assembly 120, and opened to the flow from drain path 180. Pump 140 may then pump out any liquid containing absorbent solute in evaporator 110 and pump it to separator 130, which in turn channels the absorbent to absorber 120 via flow path 132. At the end of a drainage period, valve 152 may be restored back to its normal position: closed to the drain path 180 and open to flow path 162 from absorber 120. A normal absorption cycle, such as a refrigeration cycle, may then be resumed until the next drainage period and the cycle continues.

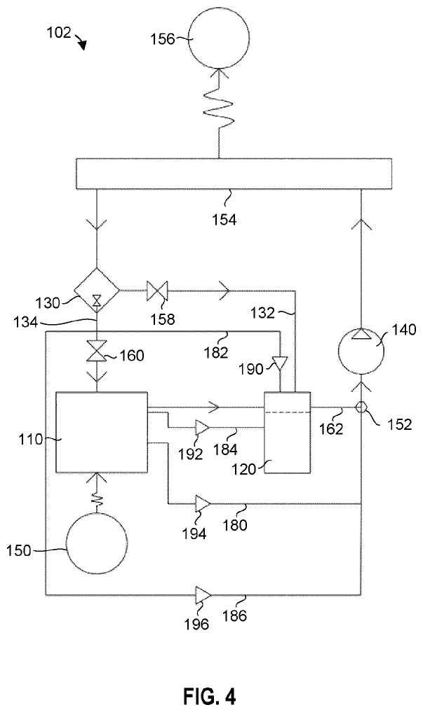

FIG. 4 is a schematic of another example embodiment of a heat pump 102 according to the present disclosure. Heat pump 102 is similar to heat pump 100 of FIG. 1 except in that it comprises multiple optional drain paths 180, 182, 184, 186. Embodiments may thus comprise one or more of drain paths 180, 182, 184, 186.

Drain path 180 was previously described. Drain path 180 may be fitted with one-way and on-off valve 194 which may be normally closed, and is opened to remove accumulated solutes, for instance to correct for imperfect solute rejection rates by a semipermeable barrier in separator 130.

Drain path 182 extends between separator 130 and absorber 120. In particular, drain path 182 originates downstream from the refrigerant outlet of separator 130 and upstream from the inlet of throttle valve 160, and terminates at absorber 120. Drain path 182 may be fitted with one-way and on-off valve 190 which may be normally closed, and is opened to remove accumulated solutes, for instance to correct for imperfect solute rejection rates by the semipermeable barrier in separator 130. A pressure difference across the inlet and outlet of drain path 182 (throttling pressure drop) drives the flow.

Drain path 184 extends between evaporator 110 and absorber 120, and may be used to remove accumulated absorbent from evaporator 110. In an embodiment, drain path 184 may be gravity assisted so the inlet of drain path 184 in a base of evaporator 110 must be higher than the outlet of drain path 184 at the top of absorber 120, and ideally the drain path is sloped downward to ensure good gravity assisted drainage. In another embodiment, rather than being gravity assisted, a pump may be used to pump absorbent from evaporator 110 to absorber 120. Drain path 184 may be fitted with one-way and on-off valve 192 which may be normally closed, and is opened to remove accumulated solutes, for instance to correct for imperfect solute rejection rates by a semipermeable barrier in separator 130.

Drain path 186 extends between separator 130 and valve 152. Pump 140 may drive the flow. Drain path 186 may be fitted with one-way and on-off valve 196 which may be normally closed, and is opened to remove accumulated solutes, for instance to correct for imperfect solute rejection rates by a semipermeable barrier in separator 130.

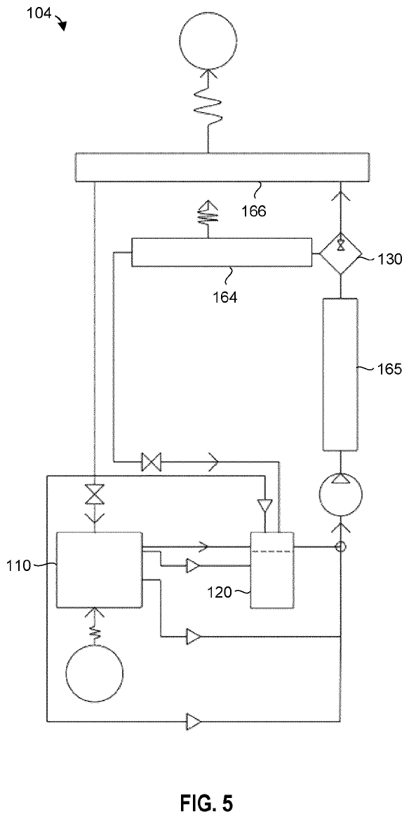

FIG. 5 is a schematic of another example embodiment of a heat pump 104 according to the present disclosure. Heat pump 104 is similar to heat pump 100 of FIG. 1 but is configured to operate with a modified absorption cycle. In particular, the modified absorption cycle involves a heat rejection process using one or more heat exchangers 164, 166 downstream of the separator 130. This is in addition to or alternatively to a heat rejection process by heat exchanger 165 upstream of separator 130, such as heat exchanger 154 in FIGS. 1 and 4. In particular, a heat exchanger 166 may be positioned in the flow path between separator 130 and evaporator 110. A heat exchanger 164 may be positioned in the flow path between separator 130 and absorber 120.

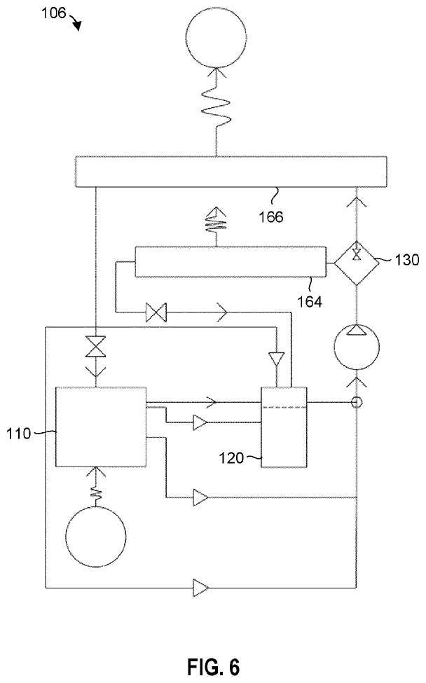

FIG. 6 is a schematic of another example embodiment of a heat pump 106 according to the present disclosure. Heat pump 106 is similar to heat pump 100 of FIG. 1 but is configured to operate with a re-sequenced absorption cycle. In particular, the modified absorption cycle involves a heat rejection process using one or more heat exchangers 164, 166 downstream of the separator 130, but no heat exchanger upstream of separator 130 such as heat exchanger 154 in FIG. 1 and FIG. 5. In this configuration, the separation process by separator 130 occurs before the heat rejection process. This configuration may be well suited for applications in which the absorption process is endothermic, meaning there is a positive enthalpy of solvation, and the separation process is exothermic.

Aside from the lithium bromide used in conventional absorption based heat pumps where water is the refrigerant, other solutes that may serve as absorbent solutes in embodiments according to the present disclosure are solutes which are non-volatile in the operating temperature and pressure range of the heat pump and which spontaneously dissolve in the solvent such as deliquescent solutes and have a high affinity for the solvent, for example are hygroscopic if the solvent is water, in the operating range. Subject to commercial membrane availability, human and/or environmental safety, and/or economic justification, alternative absorbent solutes may include but are not limited to magnesium chloride (MgCl₂), magnesium sulphate (MgSO₄), calcium chloride (CaCl²), magnesium bromide (MgBr₂), zinc bromide (ZnBr₂), zinc nitrate (Zn[NO₃]₂), mixed salt solutions, etc.

In some embodiments, a design parameter to attempt to ensure that the overall system is thermodynamically efficient may be to select a combination of refrigerant, absorbent solute and associated concentrations, and a semipermeable barrier or membrane so that one or more, and in some embodiments all or at least as many as possible, of the following hold true: the semipermeable membrane has a high rejection rate for the absorbent solute and is capable of withstanding the operating environment, the absorbent solution has a high affinity for the refrigerant at the concentrations of interest to enhance absorption, the absorbent solute has a low osmotic pressure at the concentrations of interest such as the highest concentrations in the system so as to reduce the transmembrane pressure requirements of the semipermeable membrane in a separator to enhance energy efficiency, the semipermeable membrane has low pressure drop per element to enhance energy efficiency, the semipermeable membrane has low cross-flow rate requirements for fouling prevention, the period between successive drain (the drain frequency) is set to maintain below tolerance absorbent concentrations in the evaporator while ensuring that removal of absorbent from the evaporator does not lead to too much liquid refrigerant loss which may render the system relatively thermodynamically inefficient.

For low temperature applications, antifreezes may be added to the selected refrigerant, for instance water. For even lower temperature applications, refrigerants with a low freezing point may be selected (considerations may include ethanol, for example) and an appropriate solute for the absorbent selected (considerations may include calcium chloride) with an appropriate semipermeable membrane identified and selected.

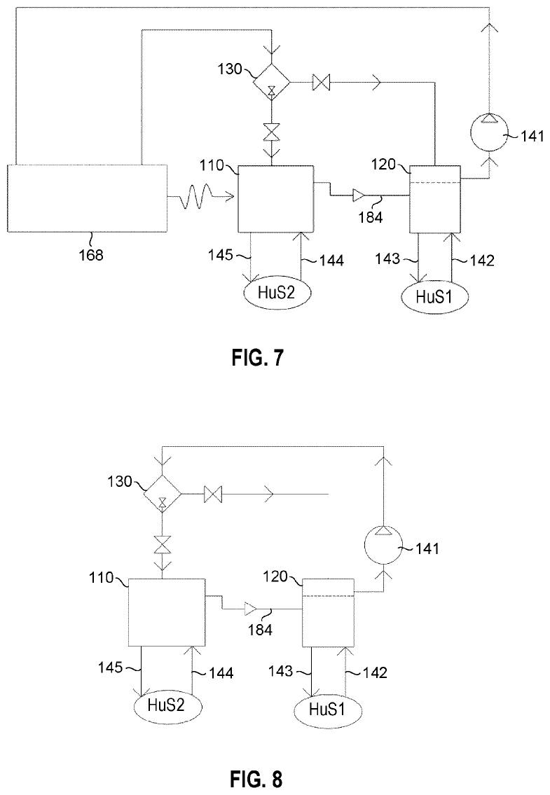

FIG. 7 and FIG. 8 are schematics of other example embodiments according to the present disclosure configured for application in desiccant dehumidification humidification applications. In these embodiments, the refrigerant is water. However, other refrigerants may be used along with a suitable absorbent in cases where humidification dehumidification is not the objective but rather extraction of some other substance, for instance, the extraction of some particular vapour or gas of interest from air or an environment.

In FIG. 7, moist air from a humidity source, HuS1, enters absorber assembly 120 from a line 142. The moisture is extracted by the absorbent, for instance aqueous lithium bromide solution, in the absorber assembly 120. The dehumidified air then returns to the humidity source HuS1 from line 143. Similar to the processes described above in heat pumps 100, 102, 104, the weak absorbent solution, for instance dilute aqueous lithium bromide solution, is then pumped via pump 141 to a heat exchanger 168 and then a separator 130 where the refrigerant is separated and sent to the evaporator 110 while the concentrated absorbent solution is sent to the absorber 120 to continue the absorption cycle. Dry air from a humidity sink HuS2 enters evaporator and heat exchanger assembly 110 from line 144. The refrigerant from separator 130 which has been sent to evaporator 110 evaporates into the dry air, humidifying it and the resulting humidified air returns to the humidity sink HuS2 via a line 145. Here, the use of refrigerant flows from and to the humidity source HuS1 and humidity sink HuS2, meaning flows in lines 142, 143, 144, 145, rather than refrigerant flow from evaporator 110 to absorber 120 as is the case in heat pumps described above, is what is herein referred to as ‘refrigerant flow decoupling’.

To aid in the evaporation of the refrigerant in evaporator 110, in cases where the solvation process is exothermic, such as the case of concentrated aqueous lithium bromide solution and water, heat (produced in absorber assembly 120) rejected in heat exchanger assembly 168 is transferred to evaporator 110 for use in a heat addition process in evaporator 110. The use of the heat which would have been rejected to a heat sink as a heat source supplying heat to evaporator 110 is what is herein referred to as ‘heat flow coupling’. Since the heat exchange in FIG. 7 occurs through a heat exchanger 168, the heat flow coupling is herein referred to as ‘external heat flow coupling’.

The embodiment of FIG. 8 is similar to the embodiment of FIG. 7 with a difference being that heat is retained in the working fluid thereby eliminating a need for a heat exchanger, herein referred to as ‘internal heat flow coupling’. Accordingly, the embodiment of FIG. 8 does not have heat exchanger 168 of FIG. 7. Absorbent solute accumulation in evaporator 110 due to imperfect solute rejection in separator 130 is periodically or continuously removed via the drain path 184 to maintain functionality by keeping the absorbent solute concentration in evaporator 110 to within tolerance levels.

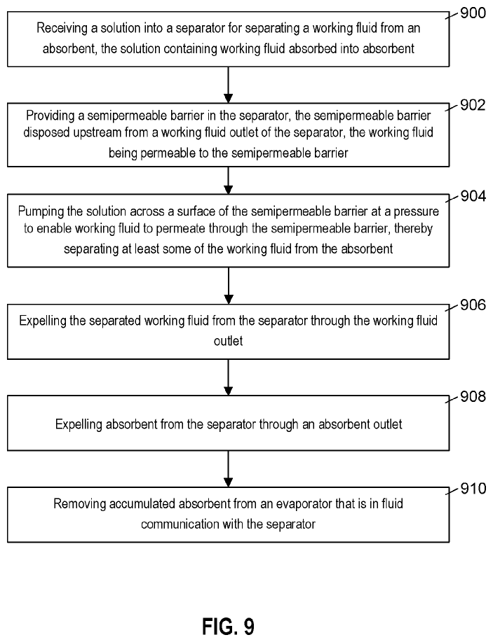

FIG. 9 is an example process flow diagram according to the present disclosure. The process may begin at block 900 where a solution is received into a separator for separating a working fluid from an absorbent, the solution containing working fluid absorbed into absorbent.

The process proceeds to block 902 where a semipermeable barrier is provided in the separator, the semipermeable barrier disposed upstream from a working fluid outlet of the separator, the working fluid being permeable to the semipermeable barrier.

The process proceeds to block 904 where the solution is pumped across a surface of the semipermeable barrier at a pressure to enable working fluid to permeate through the semipermeable barrier, thereby separating at least some of the working fluid from the absorbent.

The process proceeds to block 906 where the separated working fluid is expelled from the separator through the working fluid outlet.

The process proceeds to block 908 where absorbent is expelled from the separator through an absorbent outlet.

The process proceeds to block 910 where accumulated absorbent is removed from an evaporator that is in fluid communication with the separator.

Differential Solubility Technique for Regeneration

According to another aspect of the present disclosure, an absorption cycle process or device utilizes a differential solubility technique to regenerate the working fluid and the absorbent. In the following example embodiments, the absorption cycle process or device is in the form of a heat pump, and the working fluid is a refrigerant.

Similar to the embodiments of FIGS. 1-9, a solution containing a working fluid, such as a refrigerant, absorbed into an absorbent is received into a separator. A semipermeable barrier is provided in the separator and the semipermeable barrier disposed upstream from an absorbent outlet of the separator. Here, it is the absorbent that is permeable to the semipermeable barrier. However, according to the present differential solubility technique, a substance is provided in the separator that is not permeable to the semipermeable barrier and that reduces the solubility of a working fluid, such as the refrigerant, in the absorbent. In some embodiments, the substance significantly reduces the solubility of the working fluid in the absorbent. This substance is herein referred to as a solubility reducing substance. The solubility reducing substance mixes with the solution received into the separator to desorb at least some of the working fluid from the absorbent thereby separating at least some working fluid from the absorbent. In at least some embodiments, the solubility reducing substance is substantially not chemically consumed when it reduces the solubility of the working fluid. In this way, the absorption cycle may run without having to continually add additional solubility reducing substance.

This separation process based on the present differential solubility technique may be driven primarily by non-thermal means in cases where the solubility reducing substance solute is very effective in creating enough difference in solubility to desorb the working fluid, such as refrigerant. In cases where there is heat addition, or heat rejection, if the solubility reducing substance solute is very effective in desorbing the working fluid, then the heat addition, or heat rejection, serves only as augmentative to the separation process as opposed to a primary requirement or basic requirement for functionality. In particular, adding heat to and/or removing heat from the solution in the separator may be used to augment the solubility reducing effect of the solubility reducing substance, thereby potentially increasing the effectiveness of the separation process. A heat exchanger or any other suitable device or structure may be used for adding heat to and/or removing heat from the solution in the separator.

For example, an appropriate salt may be used as the solubility reducing substance and whose aqueous solution reduces, in some embodiments significantly, the solubility of a working fluid in an absorbent. The working fluid may be a refrigerant such as ammonia in an absorbent such as water. This may be used to drive the regeneration of both working fluid and absorbent when (i) both the refrigerant and the absorbent are permeable to the semipermeable barrier such as the case of water, ammonia and a reverse osmosis semi-permeable barrier (ii) either the working fluid or the absorbent is effervescent in the solubility reducing substance, for instance ammonia being effervescent in an appropriate salt solution under appropriate operating conditions. Again, the main energy input needed here is typically the pump work, the energy for pumping a liquid from the low pressure side (low side) of the heat pump to the high pressure side (high side) with consideration for the additional pump work needed to overcome the transbarrier or transmembrane operating pressure(s) at the semipermeable barrier. This in turn may make such an absorption system more energy efficient, ecofriendly, and/or economical for users, and/or a better contributor to global efforts to reduce carbon footprint.

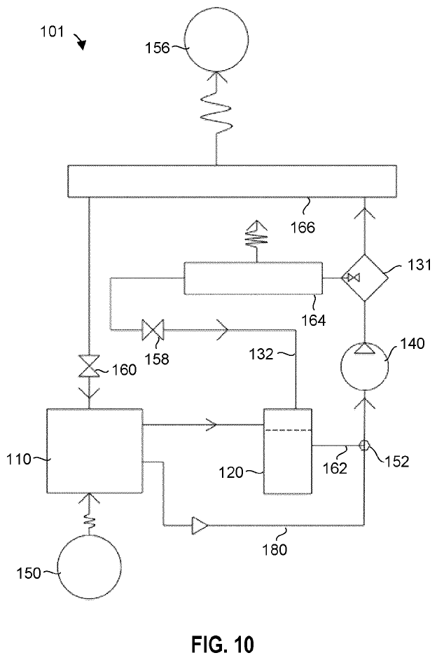

FIG. 10 is a schematic of an example embodiment of a heat pump 101 according to the present disclosure. Heat pump 101 shares many components as heat pump 100 of FIG. 1 except that heat pump 101 employs separator 131, which employs the present differential solubility technique to regenerate the refrigerant and the absorbent, in contrast to separator 130 in FIG. 1. Further, heat pump 101 of FIG. 10 is also similar to heat pump 106 of FIG. 6 in that it comprise no heat exchangers upstream from separator 131 and two heat exchangers 164, 166 downstream from separator 131.

A counterpart of heat pump 101 in conventional absorption heat pumps could be an ammonia-water absorption heat pump. Heat pump 101 may carry out some or all of the processes of an ammonia-water (NH₃—H₂O) type of conventional absorption heat pumps except for the process to regenerate refrigerant from the strong absorbent solution. As noted above, heat pump 101 has a separator 131 that employs the present differential solubility technique to regenerate the refrigerant and the absorbent.

In FIG. 10, refrigerant such as ammonia enters the evaporator 110, which may comprise a heat exchanger assembly, at a low pressure (the low side of refrigeration). It absorbs heat from a heat source 150, such as a cold refrigerated space, and evaporates in the process. The evaporated refrigerant is then absorbed by the absorbent such as weak aqueous ammonia solution in absorber assembly 120. The resulting strong absorbent solution, such as concentrated aqueous ammonia solution, then passes through valve 152 to pump 140. Valve 152 may be normally open to this absorber flow path and closed to drain path 180.

The strong absorbent solution may then be pumped to a high side of refrigeration where it enters separator 131 and is separated into refrigerant, such as ammonia gas, and weak absorbent solution, such as weak aqueous ammonia solution. The weak absorbent solution may be passed through heat exchanger assembly 164 to reject heat, as indicated by the squiggly arrow emanating from heat exchanger 164, to a heat sink such as a heated space or ambient environment. The weak absorbent solution may then be passed through a throttle valve 158 to be throttled to a low pressure (the low side of refrigeration) after which it may be passed to absorber assembly 120 to continue the absorption cycle.

The refrigerant, such as gaseous ammonia, emerging from separator 131, on the other hand, may be passed through condenser heat exchanger assembly 166 to reject heat, as indicated by the squiggly arrow emanating from heat exchanger 166, to a heat sink, such as a heated space or ambient environment 156. The refrigerant may be condensed from the gaseous state, such as ammonia gas, to a liquid state, such as liquid ammonia, in the process then throttled through throttle valve 160 to a low pressure (the low side of refrigeration) and returned to evaporator 110 to continue the refrigeration cycle.

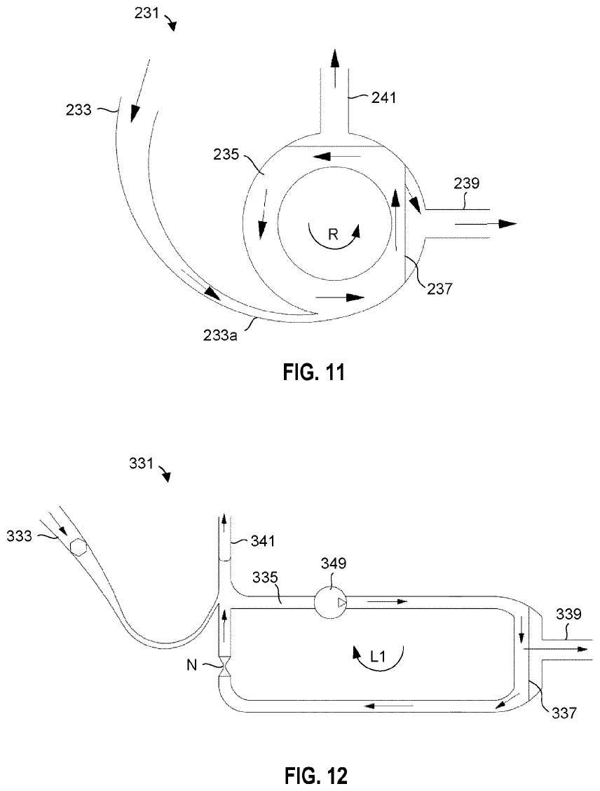

FIG. 11 is a conceptual diagram of an example embodiment of a flow and separation process in a differential solubility separator 231.

The separation operating function of differential solubility separator 231 is to contain the solute in the solubility reducing substance, for example potassium fluoride, in the control volume bound by separator 131 while allowing the absorbent and refrigerant to freely pass through that control volume thereby introducing a discontinuity in the solubility curve of the refrigerant in the absorbent (a differential solubility) along the flow path of the refrigerant absorbent solution to facilitate desorption.

In FIG. 11, strong absorbent solution from the absorber is fed to separator inlet 233. The solution is received in a chamber, channel, or other opening or volume 235 within separator 231. A semipermeable barrier 237 such as a semipermeable membrane is disposed within separator 231 between chamber 235 and an outlet 239 of separator 231. In this sense, barrier 237 is upstream from outlet 239. Outlet 239 is an absorbent outlet, and may be in fluid communication with heat exchanger 164 shown in FIG. 10. In an embodiment, barrier 237 is a cross-flow semipermeable membrane. It is noted that in the field of membrane separation, a membrane device or assembly, which may include one or more membranes, is sometimes referred to as a “membrane element”. The strong absorbent solution is passed over semipermeable barrier 237 at a pressure sufficient to enable the absorbent to permeate barrier 237.

In separator 231, for example in chamber 235, the strong absorbent solution mixes with solubility reducing substance, in which the refrigerant has a sufficiently low solubility enough to induce desorption, for example via effervescence of gaseous refrigerant and to which semipermeable barrier 237 is impermeable. The desorbed refrigerant, for example gaseous refrigerant bubbles produced from the induced effervescence, collect as separated refrigerant, such as gaseous refrigerant or refrigerant in vapor state, where it is expelled from separator 231 through working fluid or refrigerant outlet 241. Refrigerant outlet 241 may be in fluid communication with heat exchanger 166 shown in FIG. 10.

The solubility reducing substance may be confined or localised to chamber 235 bound by separator 231 as a result of one or more of the following. The semipermeable barrier 237 acts as a barrier to the solubility reducing substance flowing out through absorbent outlet 239. A high velocity of flow of the incoming solution may be generated at the separator inlet 233, which acts to counteract diffusion of the solute in solubility reducing substance through inlet 233. In other words, in an embodiment, the flow velocity of the solution through inlet 233 is higher than the speed of diffusion of the solubility reducing substance in the solution to inhibit diffusion of the solubility reducing substance outwardly of separator 231 through inlet 233. For example, separator inlet 233 having a narrowed portion, such as a nozzle in region 233a, as shown in FIG. 11, causes the inlet flow velocity to be higher than the diffusion rate of the solute of solubility reducing substance.

The orientation of refrigerant outlet 241 may have a substantially vertical orientation to ensure or promote that buoyancy assists with the separation. For example, buoyancy may keep a gaseous refrigerant such as ammonia gas up and the denser liquid solubility reducing substance down. In this regard, the refrigerant (working fluid) outlet 241 extends generally upwardly from an upper region of separator 231. The absorbent volume flow rate out of separator 231 may be selected to be equal to the volume flow rate to the separator inlet 233 for the case of gaseous refrigerant (working solution) to attempt to ensure there is no liquid accumulation in separator 231, meaning ensuring liquid volumetric continuity. The cross-flow recirculation path, indicated by arrow ‘R’ in FIG. 11, may function to reduce semipermeable barrier 237 fouling to maintain good operational performance over time.

In at least some embodiments, the refrigerant may permeate semipermeable barrier 237 and flow to absorber assembly 120. However, the amount of refrigerant flowing into absorber 120 is always less than the amount flowing into separator inlet 233 per unit volume of absorbent due to the desorbing effect of the solubility reducing substance. As a mere example, as much as 35% of the refrigerant may return to absorber 120 in some cases.

FIG. 12 is a diagram of an example embodiment of a structure for a flow and separation process in a differential solubility separator 331. Similar to the embodiment of FIG. 11, separator 331 has an inlet 333, a chamber 335 or other volume, an absorbent outlet 339, a refrigerant outlet 341, and a semipermeable barrier 337 disposed within separator 331 between chamber 335 and absorbent outlet 339. A first fluid loop L1 is formed within separator 331, as indicated in FIG. 12. Loop L1 may include a narrowing portion N in chamber or channel 335 to reduce the fluid pressure across the narrowing N.

An operating process may be similar to the one described for FIG. 11 except that a pump 349 may be used in aiding cross-flow recirculation of solution across semipermeable barrier 337. Pump 349 may be used since system pressures of separator 331 including the osmotic pressure need to be overcome to cause absorbent to flow back to the absorber assembly via outlet 339. The osmotic pressure component alone even at semipermeable barrier 337 can be very high, for example in the order of roughly 2.5 MPa for a solubility reducing substance solution at 35 degrees C. composed of 0.5 molar aqueous potassium fluoride, which may be much higher than the minimum high side pressure required for the operation of a heat pump for instance, in the order of 1.35 MPa for saturated ammonia vapour pressure around 35 degrees C. For gaseous refrigerants, such as ammonia, solubility tends to increase with pressure so separation via desorption at a high pressure may be counterproductive. As a consequence, separation may be effected in the separator at a lower pressure closer to the minimum high side pressure required for the heat pump given the operating parameters, after which pump 349 then pumps the resulting fluid in chamber 335 to a pressure high enough to overcome the separator system pressures (including the osmotic pressure, the transbarrier or transmembrane operating pressure required for the desired permeate flow rate for the semipermeable barrier used, and/or the cross-flow pressure drop across each semipermeable barrier element used) to enable the absorbent to be separated out through absorbent outlet 339.

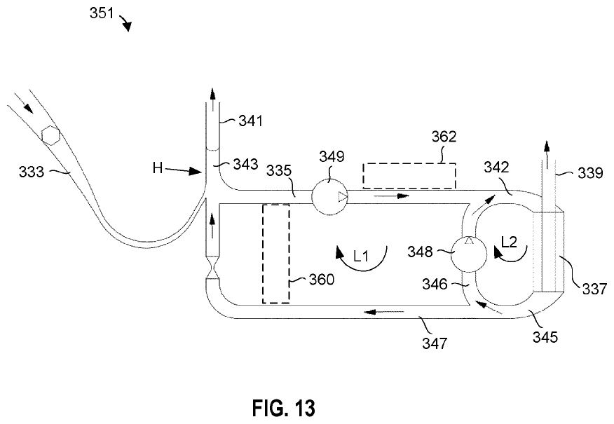

FIG. 13 is a diagram of an example embodiment of a structure for a flow and separation process in a differential solubility separator 351.

With reference to the implementation represented in FIG. 12, similar or higher efficiencies may be achieved with the embodiment according to FIG. 13 by possibly using fewer semipermeable barrier devices and by passing at least part of the solution in separator 351 across the surface of semipermeable barrier 337 multiple times. In other words, some of the solution that has passed over semipermeable barrier 337, for example solution in region 345 of separator 351, flows into channel 347 while some of the solution is directed into path or channel 346 to be reintroduced into path 342 upstream of semipermeable barrier 337. In effect, this solution in channel 346 is recirculated over semipermeable barrier 337. First fluid loop L1 and second fluid loop L2 are formed within separator 331, as indicated in FIG. 13.

The solution in channel 346 may be referred to as a high pressure recirculating stream. A pump 348 may be used to provide pressure required to overcome a cross-flow pressure drop across semipermeable barrier 337 to the high pressure recirculating stream in path 346. Pump 349 is positioned in first fluid loop L1 while pump 348 is positioned in second fluid loop L2. A high pressure recirculation ratio, defined as a percentage of the flow through region 345 flowing through high pressure recirculating stream in path 346 may be a design parameter to be selected to, for example, optimize energy efficiency since the pressure across pump 348 may be much lower than that across pump 349. For example, the pressure drop across pump 348 may be in the order of 0.1 MPa while that across pump 349 may be in the order of 5 MPa under certain operating conditions in some designs. The selection of a high pressure recirculation ratio may be an optimization problem to be solved by a designer of the system having ordinary skill in the art.

FIG. 13 additionally shows an optional first heat exchanger 360. A function of heat exchanger 360 is to transfer heat from fluids leaving a desorption chamber 343 to fluids entering or re-entering desorption chamber 343. Desorption chamber 343 may generally be considered to be an area within the overall chamber or volume 335 in separator 351 where working fluid, such as refrigerant gas, is desorbed or separated from the solution. In the embodiment of FIG. 13, this is in an area of refrigerant outlet 341. In particular, heat is transferred from solution flowing in an outwardly direction relative to desorption chamber 343 to solution in the desorption chamber 343 and/or to solution flowing in an inwardly direction relative to the desorption chamber 343. An objective may be to assist in maintaining a relatively higher temperature at desorption chamber 343 for scenarios where separation by desorption increases with increasing temperature, as for most gases such as ammonia gas, while maintaining a relatively lower temperature at semipermeable barrier 337 to help maintain lower osmotic pressures and also ensure the temperatures at the semipermeable barrier 337 are below the maximum operating temperature specified by the semipermeable barrier manufacturer. Heat exchanger 360 may not be needed in embodiments in which separation via desorption increases with decreasing temperature.

FIG. 13 additionally shows an optional second heat exchanger 362. A function of heat exchanger 362 is to transfer heat from fluids about to pass over semipermeable barrier 337 to a heat sink, such as ambient, with an objective of maintaining a relatively low temperature at semipermeable barrier 337. Furthermore, optionally, waste heat may be applied to the desorption chamber 343, as indicated by arrow ‘H’ in FIG. 13. Sources of waste heat are within the knowledge of those having ordinary skill in the art and may include process heat and heat from chimneys. An objective for applying waste heat may be again to assist in maintaining a relatively higher temperature at desorption chamber 343 for scenarios where separation by desorption increases with increasing temperature, as for most gases such as ammonia gas.

Regarding the solute for the solubility reducing substance, several different substances may be alternatively used depending on the choice of refrigerant or other working fluid. For example, for ammonia as refrigerant and water as absorbent, as used in the ammonia-water (NH₃—H₂O) type of absorption heat pumps, ammonia has been found to have reduced solubility in several aqueous salt solutions with the solubility generally reducing with increasing concentration of the salt (see Airgas 2019; Comey and Hahn 1921 p. 21). For instance, the solubility of ammonia has been reported to be in the neighbourhood of 0.839 gram moles per litre of aqueous potassium fluoride (KF) and in the neighbourhood of 0.938 gram moles per litre of aqueous sodium chloride (NaCl) salt solutions of 0.5 normal concentration at 25 degrees C. (see Airgas 2019; Comey and Hahn 1921 p. 21) as opposed to ammonia's solubility in water which is at 31% weight on weight at 25 degrees C. which is roughly 28 gram moles per litre solution (see Comey and Hahn 1921 p. 21; National Center for Biotechnology Information 2019). This represents a significant solubility reduction for the liberation of ammonia gas from concentrated aqueous ammonia solution.

As a further example regarding potential solubility reducing substances, for aqueous solutions of alkaline salts such as salts formed from weak acids and strong bases (e.g. K₂CO₃ or potassium carbonate), after dissociation in water, anion hydrolysis tends to produce excess hydroxyl ions (OH⁻ ions) which may make the salt solution alkaline. Gaseous ammonia also dissolves in water to form the alkaline aqueous ammonia, such as the strong absorbent solution in an ammonia-water heat pump, in an equilibrium reaction which also produces excess hydroxyl ions (OH⁻ ions). It follows then from the well-known Le Chåtelier's principle in equilibrium chemistry that the effect of an alkaline salt on an aqueous ammonia solution in equilibrium would be to increase the hydroxyl ion (OH⁻ ions) concentration thereby shifting the equilibrium position towards the production of ammonia gas, and as a consequence generating the gaseous refrigerant from the strong absorbent solution (i.e. concentrated ammonia solution) in the differential solubility separator. From an equilibrium chemistry viewpoint, this same Le Chåtelier's principle explains why ammonia gas is liberated from the strong absorbent solution when heated in a generator of a conventional absorption refrigerator. The forward solvation reaction is exothermic hence the addition of heat favours the backward desolvation reaction resulting in the release of ammonia gas in the aqueous ammonia solution. From a solubility viewpoint, the solubility of ammonia decreases with increasing temperature (see International Institute of Ammonia Refrigeration 2008, p. 2-27) and this is responsible for the release of ammonia gas in the aqueous ammonia solution in a generator of a conventional absorption heat pump. In a differential solubility heat pump, the solubility reducing substance is used in a differential solubility separator as opposed to temperature increase in a generator, as seen in a conventional absorption heat pump, to achieve the same solubility reduction and gaseous refrigerant regeneration objective.

To possibly increase the energy efficiency of a differential solubility heat pump, or other absorption system, according to the present disclosure, solutes for consideration for the solubility reducing substance may be selected according to one or more of the following considerations: (i) the solute greatly reduces the solubility of refrigerant in the solution to increase the cooling capacity per unit work input, (ii) the solute requires relatively low transbarrier or transmembrane operating pressures, most particularly, they generate low osmotic pressures to decrease the work input per unit cooling capacity, (iii) the semipermeable barriers or membranes employed are highly impermeable to the solute.

A design energy efficiency consideration for a designer of a specific differential solubility heat pump, or other absorption based system, may be to select a combination of refrigerant, absorbent, semipermeable barrier or membrane, and solute(s) for solubility reducing substance such that one or more of the following hold true: (i) the semipermeable barrier or membrane is capable of both confining the solute in the solubility reducing substance to the separator and withstanding the operating environment, (ii) the solute for solubility reducing substance significantly reduces the solubility of the refrigerant in absorbent (for instance to cause effervescence of gaseous refrigerant) at the concentrations of interest but does not get used up in the process of doing so, and/or (iii) the solubility reducing substance has a low osmotic pressure at the concentrations of interest so as to reduce the transmembrane pressure requirements of the semipermeable membrane.

For low temperature applications, antifreezes may be added to the selected refrigerant or absorbent. Ammonia-ethanol mixtures may be considered in place of ammonia-water mixtures, and an appropriate solute for solubility reducing substance and a semipermeable barrier may be selected. For very low temperature applications, refrigerants with a low freezing point (i.e. melting point) such as ethanol may be selected, and an appropriate absorbent, solute for solubility reducing substance, and semipermeable barrier or membrane may be selected.

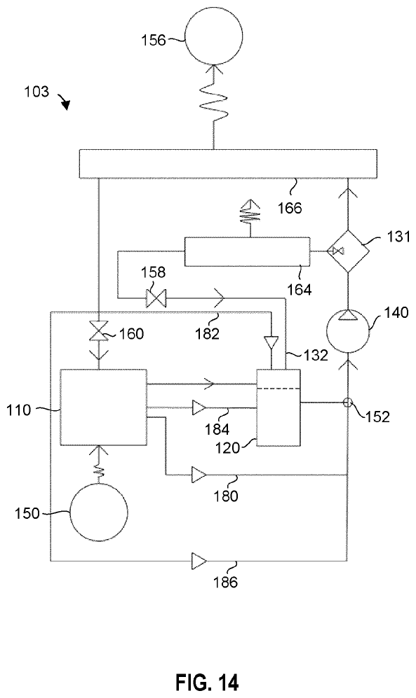

FIG. 14 is a schematic of another example embodiment of a heat pump 103 according to the present disclosure. Heat pump 103 is similar to heat pump 101 of FIG. 10 except in that it comprises multiple optional drain paths 180, 182, 184, 186. In this regard, heat pump 103 of FIG. 14 is similar to the embodiment of FIG. 4. Embodiments may thus comprise one or more of drain paths 180, 182, 184, 186. Some or all of drain paths 180, 182, 184, 186 may be equipped with one way and on-off valves, and operate in a similar manner as the drain paths in other embodiments described herein.

In designs where the separated refrigerant is a gaseous refrigerant, such as ammonia gas in the ammonia-water type absorption heat pump, the function of the drain path(s) is to provide a means in the event of a spill, for instance due to mishandling, to both drain back the solubility reducing substance solute to the separator and drain back the absorbent into the absorber. However, in designs where the separated refrigerant is a liquid refrigerant with a non-negligible solubility for the solubility reducing substance solute, in addition to providing a means to reset the fluid systems after a spill, the drain paths may also serve the function of providing a means to periodically drain back any solubility reducing substance solute accumulation in the evaporator 110, to separator 131. This is conceptually similar to the imperfect solute rejection correction function of drain paths in embodiments described above. For the case of separated refrigerant as a liquid refrigerant, liquid refrigerants with lower solubility for the solubility reducing substance solute to the point of being negligible at the operating conditions may be preferred in some embodiments. In some embodiments, the solubility reducing substance solute will preferably not be soluble in the separated refrigerant in the phase (e.g. gas or liquid) in which the separated refrigerant is separated in the separator. For example, the solubility of potassium fluoride in ammonia gas may be regarded as negligible at standard temperature operating conditions for the ammonia-water type of differential solubility heat pump.

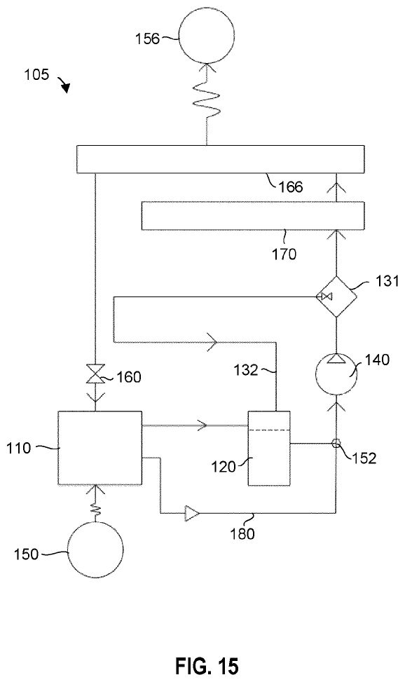

FIG. 15 is a schematic of another example embodiment of a heat pump 105 according to the present disclosure. Heat pump 105 is similar to heat pump 101 of FIG. 10 except in that heat pump 105 incorporates a separator similar to separator 351 in FIG. 13, which may take advantage of available waste heat for increasing cooling capacity. Heat pump 105 of FIG. 15 thus employs a drier 170, such as a rectifier, a refrigerant vapour selective membrane, etc. right after separator 131 to reduce the absorbent content of the desorbed refrigerant, for example the relatively higher water content of the desorbed ammonia as a consequence of the use of available waste heat to promote desorption. Moreover, the embodiment of FIG. 15 may harness the semipermeable barrier 337 in differential solubility separator 351 according to FIG. 13 as a throttling device thereby eliminating a need for an additional throttling device for the absorbent expelled from the separator via the absorbent outlet 339. This approach for eliminating a throttling valve may be employed in any suitable embodiment according to the present disclosure.

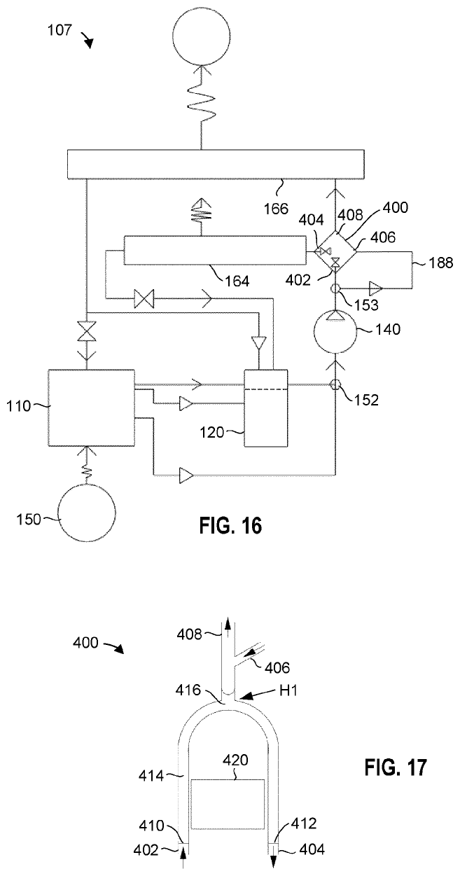

FIG. 16 is a schematic of another example embodiment of a heat pump 107 according to the present disclosure, which is similar to heat pump 101 of FIG. 10 except in that heat pump 107 utilizes a differential solubility separator 400 according to FIG. 17.

As a consequence of this difference, valve 153 is disposed between pump 140 and separator 400. Valve 153 may be normally open to direct flow from pump 140 to separator inlet 402, and closed to block the path through drain path 188 which feeds in to drain inlet 406 of separator 400. During a drainage session however, valve 153 directs the flow from pump 140 into drain path 188 and then to drain inlet 406 to restore confinement of the solubility reducing substance to the separator 400.

FIG. 17 is a diagram of a differential solubility separator 400 according to the present disclosure, which comprises an inlet 402, an absorbent outlet 404, a drain inlet 406, and a refrigerant outlet 408. Separator 400 comprises a semipermeable barrier 410 at inlet 402 and another semipermeable barrier 412 at absorbent outlet 404. Semipermeable barriers 410, 412 may be of any suitable type, including membranes. A function of semipermeable barriers 410, 412 is to largely confine the solubility reducing substance to a control volume within chamber or volume 414 within separator 400, while allowing the working fluids, such as strong absorbent solution and weak absorbent solution, to pass through chamber 414.

A feedstock, such as concentrated ammonia solution being a strong absorbent solution, may be fed from absorber 120 (FIG. 16) to separator inlet 402 of separator 400. The feedstock passes through the semipermeable barrier 410 as permeate and into the solubility reducing substance within chamber 414 where the reduced solubility of the refrigerant causes the production of the separated refrigerant, for example the production of a gaseous refrigerant through effervescence. The gaseous refrigerant collects as separated refrigerant where it then passes through refrigerant outlet 408 to subsequently flow to the condenser heat exchanger assembly 166 (FIG. 16) to continue the refrigeration cycle.

The resulting absorbent solution, such as weak ammonia solution, then passes through semipermeable barrier 412 at absorbent outlet 404 to flow ultimately to absorber 120 (FIG. 16) to continue the absorption cycle. Waste Heat H1 may be transferred into the desorption chamber 416 to enhance cooling capacity per unit work input. Desorption chamber 416 may generally be considered to be an area within the overall chamber or volume 414 in separator 400 where waste heat may be applied to aid refrigerant gas being desorbed or separated from the solution. In the embodiment of FIG. 17, this is in an area of refrigerant outlet 408.

An optional heat exchanger 420 may enable outgoing fluid to transfer heat to incoming fluid to aid desorption, again for the case where solubility decreases with increasing temperature as for most gases such as ammonia gas, while maintaining low temperatures at the semipermeable barriers 410, 412 for possible reasons such as not exceeding semipermeable barrier maximum operating temperature requirements and/or generating lower osmotic pressures to enhance energy efficiency.

The absorbent expelled from separator 400 via outlet 404 may be passed through heat exchanger assembly 164 (FIG. 16) before passing to absorber 120.

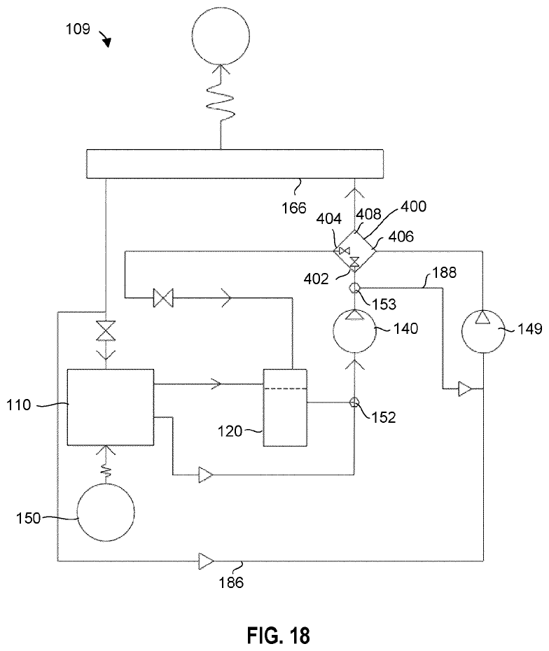

FIG. 18 is is a schematic of another example embodiment of a heat pump 109 according to the present disclosure, which is similar in some regards to heat pump 107 of FIG. 16. In FIG. 18, the absorbent expelled from outlet 404 of separator 400 may flow to absorber 120 without passing through a heat exchanger. Further, a pump 149 may be used in drain lines 186 and/or 188 to pump fluid to separator inlet 406.

In another embodiment of a differential solubility separator (not shown), the separated refrigerant may be an immiscible liquid refrigerant, which may pass through the refrigerant outlet 408 to a heat exchanger assembly rather than a condenser heat exchanger assembly 166 (FIG. 16). In this embodiment, an effect of the solubility reducing substance would be to create a fluid medium in which, though soluble in the absorbent, reduces the solubility of the absorbed refrigerant fed into the separator and renders it as an immiscible layer, for example an immiscible liquid layer of lower density than the solubility reducing substance, which then flows to the heat exchanger for cooling. Yet in other embodiments, the solubility reducing substance may be a layered immiscible fluid with the lower layer fluid inducing effervescence and the upper layer serving as a physical barrier inhibiting the equilibrium condensation of the evolved gas at the top of the differential solubility separator back into the solubility reducing substance. For example, in an embodiment, a layer of immiscible oil on top of an effervescence inducing salt solution may be used.

For ease of reference and contrast with existing thermodynamic cycles, thermodynamic cycles comprising the differential solubility technique described herein may be referred to as ‘differential solubility absorption cycles’.

For further ease of reference and contrast, differential solubility absorption cycle example embodiments which comprise all of the processes below may be referred to as ‘Barnieh refrigeration cycle’:
i. heat addition process (e.g. isobaric heat addition in evaporator),
ii. absorption process (e.g. isobaric absorption, isothermal absorption, a condensation-solvation process in an Absorber).
iii. liquid compression process (e.g. isochoric pressure increase in a pump),
iv. a desorption process by the differential solubility technique (e.g. desorption via the Differential Solubility Separators described in the current disclosure),
v. heat rejection processes (e.g. isobaric heat rejection in condensers or heat exchangers),
vi. adiabatic cooling processes (e.g. adiabatic expansion or isenthalpic expansion of fluids flowing into evaporator and/or absorber).

Moreover, a thermodynamic cycle comprising a Barnieh refrigeration cycle according to the present disclosure may include additional modifications. Example modifications include re-sequencing the processes in the Barnieh refrigeration cycle, incorporating evaporator drainage as in drain path 180 of heat pump 101 (FIG. 10), incorporating a drying process as in heat pump 105 (FIG. 15), incorporating flash gas separation, concurrently running processes in the Barnieh refrigeration cycle (for instance concurrent absorption and heat rejection), cascading Barnieh refrigeration cycles, etc.

Table 1 below illustrates example energy efficiency potential of an example differential solubility refrigerator, which is a differential solubility heat pump according to the present disclosure with the application of interest being refrigeration.

TABLE 1

| | | Ideal Differential Solubility | Ideal Vapour |
|---|---|---|---|
| | | Refrigerator (Limit from | Compression Refrigerator |
| | | 2^{nd} law of Thermodynamics: | (Limit from 2^{nd} law |
| | Differential Solubility | Ideal Differential Solubility | of Thermodynamics: |
| Parameter | Refrigerator | Absorption Cycle) | Reversed Carnot Cycle) |
| evaporator | −17.8 degrees Celsius | −17.8 degrees Celsius | −17.8 degrees Celsius |
| Temperature | (0 degrees Fahrenheit) | (0 degrees Fahrenheit) | (0 degrees Fahrenheit) |
| Condenser | 35.74 degrees Celsius | 35.74 degrees Celsius | 35.74 degrees Celsius |
| Temperature | (96.34 degrees Fahrenheit) | (96.34 degrees Fahrenheit) | (96.34 degrees Fahrenheit) |
| Pump Efficiency | 55% | 100% | Not Applicable |
| Compressor | Not Applicable | Not Applicable | 100% |
| Efficiency | | | |
| Throttling Process | Isenthalpic expansion | lsentropic expansion | lsentropic expansion |
| Refrigerant | Ammonia | Ammonia | Irrelevant |
| Absorbent | Water | Water | Not Applicable |
| Absorber | 35.74 degrees Celsius | 35.74 degrees Celsius | Not Applicable |
| Temperature | (96.34 degrees Fahrenheit) | (96.34 degrees Fahrenheit) | |
| separator Type | See Figure 13 and with | See Figure 13 and with | Not Applicable |
| | optional waste heat | optional waste heat | |
| | application H, and optional | application H, and optional | |
| | heat exchangers 360 and | heat exchangers 360 and | |
| | 362 excluded | 362 excluded | |
| separator High | 82% | 82% | Not Applicable |
| Pressure | | | |
| Recirculation Ratio | | | |
| separator solubility | solubility reducing | solubility reducing | Not Applicable |
| reducing substance | substance solute: | substance solute: | |
| | Potassium Fluoride | Potassium Fluoride | |
| | solubility reducing | solubility reducing | |
| | substance solute | substance solute | |
| | concentration at Pump 2 | concentration at Pump 2 | |
| | inlet: 0.5 M | inlet: 0.5 M | |
| | solubility reducing | solubility reducing | |
| | substance Temperature = | substance Temperature = | |
| | Absorber Temperature | Absorber Temperature | |
| separator Semi- | Modelled after LANXESS AG | Modelled after LANXESS AG | Not Applicable |
| Permeable | (2019): | (2019): | |
| Membrane Element | Recovery rate: 15% | Recovery rate: 15% | |
| | Flux: 30.6 cubic meters | Flux: 30.6 cubic meters per | |
| | per day at 10.6 bar applied | day at 10.6 bar applied | |
| | pressure. | pressure. | |
| | Salt Rejection Rate | Salt Rejection Rate | |
| | (Minimum Solute Rejection | (Minimum Solute Rejection | |
| | Rate): 99% | Rate): 99% | |
| | Cross flow pressure drop | Cross flow pressure drop | |
| | per membrane element: 1 bar | per membrane element: 1 bar | |
| | Number of semi-permeable | Number of semi-permeable | |
| | membrane elements: 1 | membrane elements: 1 | |
| Assumptions | Conservative assumption | Conservative assumption | |
| | that Ammonia Solubility in | that Ammonia Solubility in | |
| | Water at 35.74 degrees | Water at 35.74 degrees | |
| | Celsius (96.34 degrees | Celsius (96.34 degrees | |
| | Fahrenheit) equals that at | Fahrenheit) equals that at | |
| | 40 degrees Celsius (104 | 40 degrees Celsius (104 | |
| | degrees Fahrenheit) at 1 | degrees Fahrenheit) at 1 | |
| | atmosphere of pressure. | atmosphere of pressure. | |
| | Impact of semi-permeable | Impact of semi-permeable | |
| | membrane imperfect salt | membrane imperfect salt | |
| | rejection (1% permeability | rejection (1% permeability | |
| | per membrane filtration | per membrane filtration | |
| | stage) on Refrigerant | stage) on Refrigerant | |
| | Absorption in Absorber is no | Absorption in Absorber is no | |
| | more than a molar solubility | more than a molar solubility | |
| | reduction of 1%. | reduction of 1%. | |
| | The impact of the relaxation | The impact of the relaxation | |
| | of this assumption can be | of this assumption can be | |
| | mitigated by: | mitigated by: | |
| | (1) appropriately reducing | (1) appropriately reducing | |
| | the solubility reducing | the solubility reducing | |
| | substance solute | substance solute | |
| | concentration with particular | concentration with particular | |
| | attention paid to exploiting | attention paid to exploiting | |
| | the shape of the refrigerant | the shape of the refrigerant | |
| | solubility versus solubility | solubility versus solubility | |
| | reducing substance | reducing substance | |
| | concentration curve, | concentration curve, | |
| | especially exploitatively | especially exploitatively | |
| | operating within any sharp | operating within any sharp | |
| | slopes in the curve. This has | slopes in the curve. This has | |
| | an added advantage of | an added advantage of | |
| | reducing pump pressure | reducing pump pressure | |
| | required to overcome | required to overcome | |
| | osmotic pressure which | osmotic pressure which | |
| | increases COP. | increases COP. | |
| | (2) increasing the stages of | (2) increasing the stages of | |
| | filtration in the separator | filtration in the separator | |
| | although this comes with the | although this comes with the | |
| | price of increasing pressure | price of increasing pressure | |
| | requirements which reduces | requirements which reduces | |
| | COP. | COP. | |
| | Refrigerant solubility in | Refrigerant solubility in | |
| | absorbent in Absorber | absorbent in Absorber | |
| | obeys the more | obeys the more | |
| | conservative of Raoult's law | conservative of Raoult's law | |
| | and Henry's Law (i.e. least | and Henry's Law (i.e. least | |
| | solubility for least | solubility for least | |
| | absorption). | absorption). | |
| | Refrigerant solubility in | Refrigerant solubility in | |
| | absorbent in separator | absorbent in separator | |
| | obeys the more | obeys the more | |
| | conservative of Raoult's law | conservative of Raoult's law | |
| | and Henry's Law (i.e. | and Henry's Law (i.e. | |
| | highest solubility for least | highest solubility for least | |
| | desorption). | desorption). | |
| | Conservative values of | Conservative values of | |
| | specific volume of ammonia | specific volume of ammonia | |
| | solution at various | solution at various | |
| | temperatures when aqua | temperatures when aqua | |
| | ammonia charts are | ammonia charts are | |
| | imprecise. | imprecise. | |
| | Osmotic Pressures of all | Osmotic Pressures of all | |
| | solutions obey the van't Hoff | solutions obey the van't Hoff | |
| | osmotic pressure equation. | osmotic pressure equation. | |
| | Conservative assumption | Conservative assumption | |
| | that transmembrane | that transmembrane | |
| | operating pressure | operating pressure | |
| | requirement reductions as a | requirement reductions as a | |
| | consequence of the use of a | consequence of the use of a | |
| | membrane area larger than | membrane area larger than | |
| | absolutely required for the | absolutely required for the | |
| | flow rate (integer condition: | flow rate (integer condition: | |
| | no use of fractions of a | no use of fractions of a | |
| | membrane element) given | membrane element) given | |
| | the 30.6 cubic meters per | the 30.6 cubic meters per | |
| | day flux at 10.6 bar applied | day flux at 10.6 bar applied | |
| | pressure from membrane | pressure from membrane | |
| | manufacturer data sheet, | manufacturer data sheet, | |
| | are not passed on to pump. | are not passed on to pump. | |
| | Pipe pressure losses due to | Pipe pressure losses due to | |
| | fluid flow are negligible. | fluid flow are negligible. | |
| COP_{Refrigerator} | 15.82 | 29.44 | 4.77 |
| Reference Vapour | 4 | 4 | 4 |
| Compression | | | |
| Refrigerator COP | | | |
| for calculating | | | |
| energy savings | | | |
| below | | | |
| Energy Savings | 74.7% | 86.4% | 16.1% |

Heat pumps may be used in various applications, including but not limited to heaters, chillers, refrigerators, freezers, air conditioners, dehumidifiers, humidifiers, heating ventilation and air conditioning systems (HVAC), and atmospheric water generators (AWGs) among others.

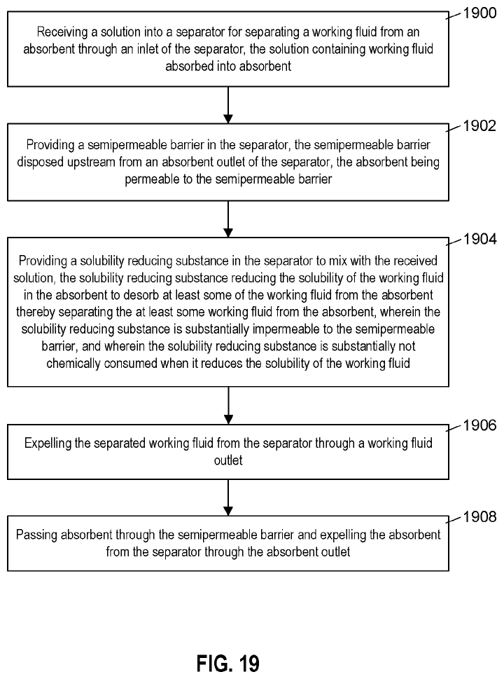

FIG. 19 is an example process flow diagram according to the present disclosure. The process may begin at block 1900 where a solution is received into a separator for separating a working fluid from an absorbent through an inlet of the separator. The solution contains working fluid absorbed into absorbent.

The process proceeds to block 1902 where a semipermeable barrier is provided in the separator. The semipermeable barrier is disposed upstream from an absorbent outlet of the separator, and the absorbent is permeable to the semipermeable barrier.

The process proceeds to block 1904 where a solubility reducing substance is provided in the separator to mix with the received solution. The solubility reducing substance reduces the solubility of the working fluid in the absorbent to desorb at least some of the working fluid from the absorbent thereby separating the at least some working fluid from the absorbent. The solubility reducing substance is substantially impermeable to the semipermeable barrier, and the solubility reducing substance is substantially not chemically consumed when it reduces the solubility of the working fluid.

The process proceeds to block 1906 where the separated working fluid is expelled from the separator through a working fluid outlet.

The process proceeds to block 1908 where absorbent is passed through the semipermeable barrier and is expelled from the separator through the absorbent outlet.

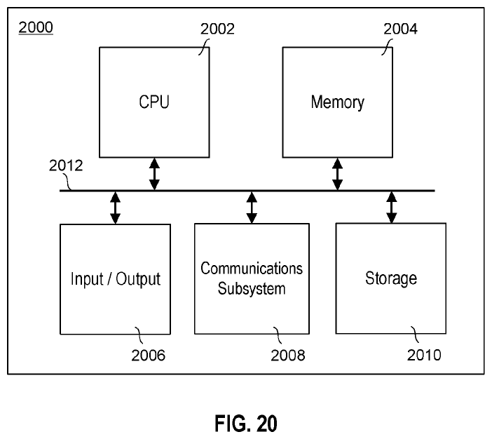

FIG. 20 is a block diagram of an example computerized device or system 2000 that may be used in implementing one or more aspects or components of an embodiment according to the present disclosure. For example, system 2000 may be used to implement a computing device or system, such as a controller, to be used with a device, system or method according to the present disclosure.

Computerized system 2000 may include one or more of a central processing unit (CPU) 2002, memory 2004, a mass storage device 2010, an input/output (I/O) interface 2006, and a communications subsystem 2008. One or more of the components or subsystems of computerized system 2000 may be interconnected by way of one or more buses 2012 or in any other suitable manner.

The bus 2012 may be one or more of any type of several bus architectures including a memory bus, storage bus, memory controller bus, peripheral bus, or the like. The CPU 2002 may comprise any type of electronic data processor. The memory 2004 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 2010 may comprise any type of storage device configured to store data, programs, and other information and to make the data, programs, and other information accessible via the bus 2012. The mass storage device 2010 may comprise one or more of a solid state drive, hard disk drive, a magnetic disk drive, an optical disk drive, or the like. In some embodiments, data, programs, or other information may be stored remotely, for example in the cloud. Computerized system 2000 may send or receive information to the remote storage in any suitable way, including via communications subsystem 2008 over a network or other data communication medium.

The I/O interface 2006 may provide interfaces for enabling wired and/or wireless communications between computerized system 2000 and one or more other devices or systems, such as an absorption system and/or a separator according to the present disclosure. Furthermore, additional or fewer interfaces may be utilized. For example, one or more serial interfaces such as Universal Serial Bus (USB) (not shown) may be provided.

Computerized system 2000 may be used to configure, operate, control, monitor, sense, and/or adjust devices, systems, and/or methods according to the present disclosure.

A communications subsystem 2008 may be provided for one or both of transmitting and receiving signals. Communications subsystems may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, WiFi™ (e.g. IEEE 802.11), WiMAX (e.g. IEEE 802.16), Bluetooth™, or Near-field communications (NFC), as well as GPRS, UMTS, LTE, LTE-A, and dedicated short range communication (DSRC). Communication subsystem 2008 may include one or more ports or other components (not shown) for one or more wired connections. Additionally or alternatively, communication subsystem 2008 may include one or more transmitters, receivers, and/or antenna elements (none of which are shown).

Computerized system 2000 of FIG. 20 is merely an example and is not meant to be limiting. Various embodiments may utilize some or all of the components shown or described. Some embodiments may use other components not shown or described but known to persons skilled in the art.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and alternatives of specific embodiments described herein and shown in the Figures are intended to apply generally to all of the teachings of the present disclosure, including to all of the embodiments described and illustrated herein, and regardless of any headings used herein, insofar as they are compatible. In other words, the structure, features, accessories, and alternatives of a specific embodiment are not intended to be limited to only that specific embodiment unless so indicated.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The above-described embodiments are intended to be examples only. Alterations, modifications and variations may be effected to the particular embodiments by those of skill in the art without departing from the scope, which is defined solely by the claims appended hereto.

### REFERENCES

Airgas, 2019. Accessed: 5 Apr. 2019. Solubility of Ammonia in Aqueous Salt Solution at 25° C. Online: https://airgasspecialtyproducts.com/wp-content/uploads/2016/02/Solubility_of_Ammonia_in_Aqueous_Salt_Solutions_at_25%C2%BA C_.pdf

Comey, A. M and Hahn, D. A., 1921. A Dictionary of Chemical Solubilities: Inorganic. The Macmillan Company

International Institute of Ammonia Refrigeration, 2008. Accessed: 5 Apr. 2019. Properties of Ammonia. In Ammonia Data Book. Online: http://web.iiar.org/membersonly/PDF/CO/databook_ch2.pdf

Johnson Controls, 2018. Accessed: 3 Jul. 2019. YORK® Commercial & Industrial HVAC 2018. Online: https://www.johnsoncontrols.comNmedia/jci/global-capabilities/be/files/be_york_industrial_commercial_hvac_2018.pdf

LANXESS AG, 2019. Accessed 15 May 2019. Product Information Lewabrane® RO B440 LE. Online: http://lpt.lanxess.com/en/products-lpt/product-groups/reverse-osmosis/lewabrane-ro-b440-le/

National Center for Biotechnology Information, 2019. Ammonia. Accessed: 5 Apr. 2019. Online: https://pubchem.ncbi.nlm.nih.gov/compound/ammonia#section=Solubility

Synder® Filtration, 2019. Accessed 15 May 2019. Sanitary Nanofiltration Spiral-Wound Element: NFS (100-250 Da). Online: http://synderfiltration.com/Sanitary-Nanofiltration-Spiral-Wound-Element/nfs-tfc-100-250da-sanitary/

1. A method comprising:
receiving a solution into a separator for separating a working fluid from an absorbent through an inlet of the separator, the solution containing working fluid absorbed into absorbent;
providing a semipermeable barrier in the separator, the semipermeable barrier disposed upstream from an absorbent outlet of the separator, the absorbent being permeable to the semipermeable barrier;
providing a solubility reducing substance in the separator to mix with the received solution, the solubility reducing substance reducing the solubility of the working fluid in the absorbent to desorb at least some of the working fluid from the absorbent thereby separating the at least some working fluid from the absorbent, wherein the solubility reducing substance is substantially impermeable to the semipermeable barrier, and wherein the solubility reducing substance is substantially not chemically consumed when it reduces the solubility of the working fluid;
expelling the separated working fluid from the separator through a working fluid outlet; and
passing absorbent through the semipermeable barrier and expelling the absorbent from the separator through the absorbent outlet.

2. The method of claim 1, wherein desorbing the working fluid from the absorbent involves at least in part vaporizing the absorbed working fluid into gaseous form by effervescence.

3. The method of claim 1, wherein the solubility reducing substance comprises a salt.

4. The method of claim 1, wherein the working fluid comprises ammonia and the absorbent comprises water.

5. The method of claim 1, to wherein the working fluid outlet extends generally upwardly from an upper region of the separator containing the solution to promote the separating of the working fluid from the absorbent when the separated working fluid is in gaseous form.

6.-8. (canceled)

9. The method of claim 1, comprising circulating the solution in the separator in a first channel forming a first fluid loop, the first channel in fluid communication with the semipermeable barrier.

10.-13. (canceled)

14. The method of claim 1, wherein the semipermeable barrier comprises a semipermeable membrane.

15. (canceled)

16. The method of claim 1, comprising adding heat to and/or removing heat from the solution in the separator to augment the solubility reducing effect of the solubility reducing substance.

17.-18. (canceled)

19. The method of claim 1, wherein the separator is a part of a heat pump, and the working fluid is a refrigerant.

20. An apparatus, comprising:
a separator for separating a working fluid from an absorbent, the separator comprising:
an inlet for receiving a solution into the separator, the solution containing working fluid absorbed into absorbent;
an absorbent outlet for expelling absorbent from the separator;
a working fluid outlet for expelling separated working fluid from the separator; and
a semipermeable barrier disposed upstream from the absorbent outlet,
wherein a solubility reducing substance is receivable into the separator to mix with the received solution, the solubility reducing substance reducing the solubility of the working fluid in the absorbent to desorb at least some of the working fluid from the absorbent thereby separating the at least some working fluid from the absorbent, wherein the solubility reducing substance is substantially impermeable to the semipermeable barrier, and wherein the solubility reducing substance is substantially not chemically consumed when it reduces the solubility of the working fluid,
wherein the semipermeable barrier is configured to permeate absorbent through the semipermeable barrier, and the separator is configured to expel the permeated absorbent through the absorbent outlet.

21. The apparatus of claim 20, wherein desorbing the working fluid from the absorbent involves at least in part vaporizing the absorbed working fluid into gaseous form by effervescence.

22. The apparatus of claim 20, wherein the working fluid outlet extends generally upwardly from an upper region of the separator containing the solution to promote the separating of the working fluid from the absorbent when the separated working fluid is in gaseous form.

23.-24. (canceled)

25. The apparatus of claim 20, wherein the separator defines a first channel forming a first fluid loop for circulating the solution in the separator, the first channel in fluid communication with the semipermeable barrier.

26.-29. (canceled)

30. The apparatus of claim 20, wherein the semipermeable barrier comprises a semipermeable membrane.

31. (canceled)

32. The apparatus of claim 20, comprising a heat exchanger for adding heat to and/or removing heat from the solution in the separator to augment the solubility reducing effect of the solubility reducing substance.

33.-34. (canceled)

35. The apparatus of claim 20, wherein the separator is a part of a heat pump, and the working fluid is a refrigerant.

36. The apparatus of claim 20, comprising the solubility reducing substance.

37. The apparatus of claim 36, wherein the solubility reducing substance comprises a salt.

38. The apparatus of claim 20, wherein the working fluid comprises ammonia and the absorbent comprises water.

39.-58. (canceled)

59. A kit comprising:
a separator for separating a working fluid from an absorbent, the separator comprising:
an inlet for receiving a solution into the separator, the solution containing working fluid absorbed into absorbent;
an absorbent outlet for expelling absorbent from the separator;
a working fluid outlet for expelling separated working fluid from the separator; and
a semipermeable barrier disposed or positionable upstream from the absorbent outlet,
wherein a solubility reducing substance is receivable into the separator to mix with the received solution, the solubility reducing substance reducing the solubility of the working fluid in the absorbent to desorb at least some of the working fluid from the absorbent thereby separating the at least some working fluid from the absorbent, wherein the solubility reducing substance is substantially impermeable to the semipermeable barrier, and wherein the solubility reducing substance is substantially not chemically consumed when it reduces the solubility of the working fluid,
wherein the semipermeable barrier is configured to permeate absorbent through the semipermeable barrier, and the separator is configured to expel the permeated absorbent through the absorbent outlet.
